(19) United States
(12) Patent Application Publication
(10) Pub. No.: US 2025/0226738 A1
(43) Pub. Date: Jul. 10, 2025

(54) POWER CONVERTER, MOTOR DRIVER, AND REFRIGERATION-CYCLE APPLIED EQUIPMENT

(71) Applicant: Mitsubishi Electric Corporation, Tokyo (JP)

(72) Inventors: Takaaki TAKAHARA, Tokyo (JP); Koichi ARISAWA, Tokyo (JP); Haruka MATSUO, Tokyo (JP); Tomohiro KUTSUKI, Tokyo (JP); Yusuke MORIMOTO, Tokyo (JP); Yuya KONDO, Tokyo (JP)

(21) Appl. No.: 18/703,855

(22) PCT Filed: Dec. 10, 2021
(86) PCT No.: PCT/JP2021/045666

§ 371 Date: Apr. 23, 2024

(51) Int. Cl. H02M 1/12; H02M 3/335; H02M 7/06; H02M 7/537; H02P 27/00

(52) U.S. Cl. CPC H02M 1/12; H02M 3/33553; H02M 7/06; H02M 7/537; F25B 2600/021; H02P 27/00

(57) ABSTRACT

A power converter includes: a rectifier that rectifies a first alternating-current power supplied from an alternating-current power supply; a smoother connected to an output end of the rectifier; an inverter that is connected across the smoother, converts a first direct-current power output from the rectifier and the smoother into a second alternating-current power, and outputs the second alternating-current power to a motor; a controller that controls an operation of the inverter such that the second alternating-current power containing pulsation according to pulsation of power flowing into the smoother from the rectifier is output from the inverter to the motor; a DC-DC converter that includes at least one switching element, is connected across the smoother, and converts the first direct-current power into a second direct-current power by causing the switching element to perform switching; and a DC-DC converter controller that causes the switching element to perform switching.

### CROSS-REFERENCE TO RELATED APPLICATION

This application is a U.S. national stage application of PCT/JP2021/045666 filed on Dec. 10, 2021, the contents of which are incorporated herein by reference.

### FIELD

The present disclosure relates to a power converter that converts an alternating-current power into a desired power, a motor driver, and a refrigeration-cycle applied equipment.

### BACKGROUND

There is a conventional power converter that converts an alternating-current power supplied from an alternating-current power supply into a desired alternating-current power and supplies the alternating-current power to a load such as an air conditioner. For example, Patent Literature 1 discloses a technique in which a power converter, which is a control apparatus of an air conditioner, rectifies an alternating-current power supplied from an alternating-current power supply by a diode stack, which is a rectifier, further converts a power smoothed by a smoothing capacitor into a desired alternating-current power by an inverter constituted by a plurality of switching elements, and outputs the alternating-current power to a compressor motor, which is a load.

### PATENT LITERATURE

Patent Literature 1: Japanese Patent Application Laid-open No. H07-71805

However, the above-described conventional technique has a problem that a large current flows through a smoothing capacitor, which accelerates the aging deterioration of the smoothing capacitor. In order to cope with such a problem, a method of increasing the capacitance of a smoothing capacitor to control a ripple change in the capacitor voltage or using a smoothing capacitor with a large resistance to degradation due to ripple is conceivable, but such a method increases the cost of capacitor components and the size of the apparatus.

### SUMMARY

The present disclosure has been made in view of the above, and a purpose thereof is to obtain a power converter capable of suppressing an increase in size of the apparatus while suppressing deterioration of a smoothing capacitor.

To solve the above problems and achieve the object, a power converter according to the present disclosure includes: a rectifier configured to rectify a first alternating-current power supplied from an alternating-current power supply; a smoother connected to output ends of the rectifier; an inverter connected across the smoother, and configured to convert a first direct-current power output from the rectifier and the smoother into a second alternating-current power; and output the second alternating-current power to a motor; a first controller configured to control an operation of the inverter such that the second alternating-current power containing pulsation according to pulsation of power flowing into the smoother from the rectifier is output from the inverter to the motor; a DC-DC converter comprising at least one switching element and being connected across the smoother, the DC-DC converter is configured to convert the first direct-current power into a second direct-current power by causing the switching element to perform switching; and a second controller configured to cause the switching element to perform switching while changing, according to pulsation of power flowing into the smoother from the rectifier, a duty ratio when the switching element performs switching.

A power converter according to the present disclosure has an effect of suppressing an increase in size of the apparatus while suppressing deterioration of a smoothing capacitor.

### BRIEF DESCRIPTION OF DRAWINGS

FIG. 1 is a diagram illustrating a schematic configuration of a power conversion system implemented by applying a power converter according to a first embodiment.

FIG. 2 is a diagram illustrating a configuration example of the power converter according to the first embodiment.

FIG. 3 is a diagram illustrating examples of each current and a smoothing capacitor voltage of a smoothing capacitor of a smoother when the current output from a rectifier is smoothed by the smoother and the current flowing through an inverter is made constant, as a comparative example.

FIG. 4 is a diagram illustrating examples of each current and a smoothing capacitor voltage of the smoothing capacitor of the smoother when a controller of the power converter according to the first embodiment controls the operation of the inverter to reduce the current flowing through the smoother.

FIG. 5 is a diagram illustrating other examples of each current and a smoothing capacitor voltage of the smoothing capacitor of the smoother when the controller of the power converter according to the first embodiment controls the operation of the inverter to reduce the current flowing through the smoother.

FIG. 6 is a diagram illustrating a configuration example of a DC-DC converter of the power converter according to the first embodiment.

FIG. 7 is a diagram illustrating another configuration example of the power converter according to the first embodiment.

FIG. 8 is a diagram illustrating examples of waveforms indicating the operation of the DC-DC converter constituting the power converter according to the first embodiment.

FIG. 9 is a diagram illustrating other examples of waveforms indicating the operation of the DC-DC converter constituting the power converter according to the first embodiment.

FIG. 10 is a diagram illustrating other examples of waveforms indicating the operation of the DC-DC converter constituting the power converter according to the first embodiment.

FIG. 11 is a diagram illustrating a modification of the power converter according to the first embodiment.

FIG. 12 is a diagram illustrating an example of a hardware configuration implementing the controller included in the power converter.

FIG. 13 is a diagram illustrating a configuration example of a refrigeration-cycle applied equipment according to a second embodiment.

### DETAILED DESCRIPTION

Hereinafter, a power converter, a motor driver, and a refrigeration-cycle applied equipment according to an embodiment of the present disclosure will be described in detail with reference to the drawings.

### First Embodiment

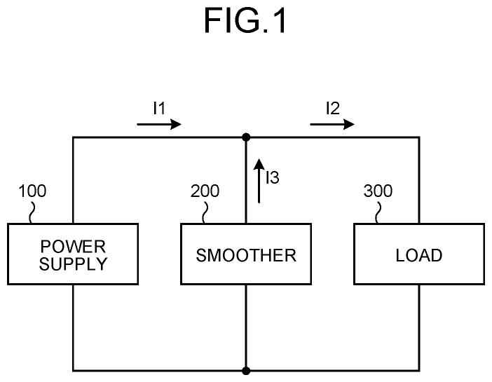

FIG. 1 is a diagram illustrating a schematic configuration of a power conversion system implemented by applying a power converter according to a first embodiment. As illustrated in FIG. 1, the power conversion system according to the first embodiment includes: a power supply 100 constituted by a commercial power supply, a rectifier circuit, and the like; a smoother 200 constituted by a smoothing element such as an electrolytic capacitor; and a load 300 constituted by a motor, an inverter that drives the motor, and the like.

In the power supply 100, an alternating-current (AC) power supplied from an alternating-current power supply such as a commercial power supply is rectified by the rectifier circuit. The rectified power is output to the smoother 200. The smoother 200 smooths a direct-current (DC) power that is the rectified power output from the power supply 100. The smoothed DC power is output to the load 300 and consumed by the motor constituting the load 300.

Here, in the first embodiment, when the current output from the power supply 100 to the smoother 200 and the load 300 is I1, the current input to the load 300 is I2, and the current flowing out of the smoother 200 is I3, a relationship of I3=I2−I1 holds. Note that when the current I1 is larger than the current I2, the current flows into the smoother 200. This relationship indicates that the current I3 flowing into and out of the smoother 200 becomes small as the current I2 approaches the current I1. If the state in which the current I3 is small, that is, the state in which the difference between the current I2 and the current I1 is small can be maintained, the smoothing element constituting the smoother 200 can be downsized.

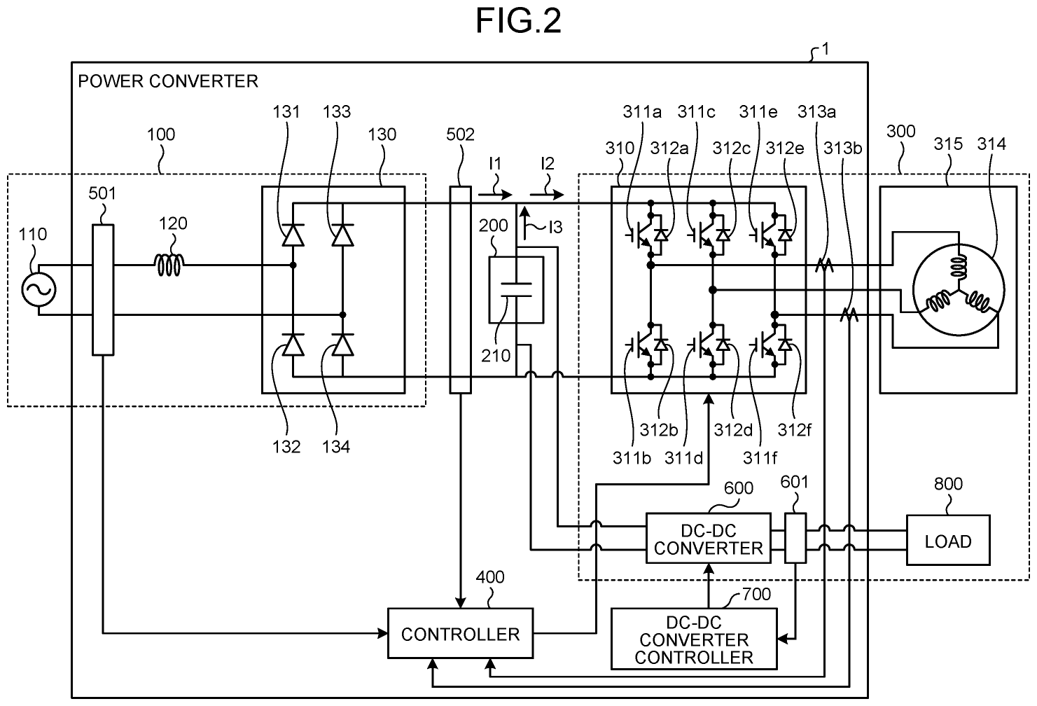

FIG. 2 is a diagram illustrating a configuration example of a power converter 1 according to the first embodiment. As illustrated in FIG. 2, the power converter 1 is connected to an AC power supply 110 such as a commercial power supply, a motor 314 constituting a compressor 315, and a load 800. The power converter 1 converts a first AC power supplied from the AC power supply 110 into a second AC power that is a three-phase alternating-current power having a desired amplitude and phase, and supplies the second AC power to the motor 314. The compressor 315 including the motor 314 is, for example, a hermetic compressor to be applied to an air conditioner. In addition, the power converter 1 converts the first AC power supplied from the AC power supply 110 into a DC power and supplies the DC power to the load 800. The load 800 is, for example, an electronic component such as a microcontroller or an integrated circuit (IC) constituting a device to which the power converter 1 is applied. A microcontroller that implements an electronic component included in the power converter 1, for example, a controller 400 may be the load 800.

The power converter 1 includes: a voltage-current detector 501; a reactor 120; a rectifier 130; a voltage detector 502; the smoother 200; an inverter 310; the controller 400; a DC-DC converter 600; a voltage detector 601; and a DC-DC converter controller 700. The reactor 120 and the rectifier 130 constitute a power supply 100 of the power conversion system illustrated in FIG. 1. The inverter 310 and the compressor 315, and the DC-DC converter 600 and the load 800 constitute the load 300 of the power conversion system illustrated in FIG. 1.

The voltage-current detector 501 detects a voltage value and current value of the first AC power of a power supply voltage Vs supplied from the AC power supply 110, and outputs the detected voltage value and current value to the controller 400. The reactor 120 is connected between the voltage-current detector 501 and the rectifier 130. The rectifier 130 includes a bridge circuit constituted by rectifier elements 131 to 134, and rectifies and outputs the first AC power of the power supply voltage Vs supplied from the AC power supply 110. The rectifier 130 performs full-wave rectification. The voltage detector 502 detects a voltage value of the power rectified by the rectifier 130 and outputs the detected voltage value to the controller 400. The smoother 200 is connected to output ends of the rectifier 130 via the voltage detector 502. The smoother 200 includes a smoothing capacitor 210 as a smoothing element and smooths the power rectified by the rectifier 130. The smoothing capacitor 210 is, for example, an electrolytic capacitor, a film capacitor, or the like. The smoothing capacitor 210 has a capacity for smoothing the power rectified by the rectifier 130. The voltage generated in the smoothing capacitor 210 by smoothing does not have a full-wave rectified waveform shape of the AC power supply 110, but has a waveform shape in which a voltage ripple according to the frequency of the AC power supply 110 is superimposed on the DC component, and does not pulsate significantly. The frequency of the voltage ripple is a component twice the frequency of the power supply voltage Vs when the AC power supply 110 is single-phase, and a component six times the frequency of the power supply voltage Vs is the main component when the AC power supply 110 is three-phase. When the power input from the AC power supply 110 and the power output from the inverter 310 do not change, the amplitude of the voltage ripple is determined by the capacitance of the smoothing capacitor 210. For example, the voltage pulsates in such a range that the maximum value of the voltage ripple generated in the smoothing capacitor 210 is less than 2 times the minimum value.

The inverter 310 is connected across the smoother 200, that is, the smoothing capacitor 210. The inverter 310 includes switching elements 311a to 311f and freewheeling diodes 312a to 312f. The inverter 310 turns on and off the switching elements 311a to 311f under the control of the controller 400, converts the first DC power, which is the power output from the rectifier 130 and the smoother 200, into the second AC power having the desired amplitude and phase, and outputs the second AC power to the compressor 315. Each of current detectors 313a and 313b detects a current value of one phase among the three-phase current output from the inverter 310, and outputs the detected current value to the controller 400. Note that the controller 400 can calculate the current value of the remaining one phase output from the inverter 310 by acquiring the current values of the two phases among the current values of three phases output from the inverter 310. The compressor 315 is a load including the motor 314 for driving the compressor. The motor 314 rotates according to the amplitude and phase of the second AC power supplied from the inverter 310 and performs a compression operation. For example, when the compressor 315 is a hermetic compressor used in an air conditioner or the like, the load torque of the compressor 315 can be regarded as a constant torque load in many cases.

Note that, in the power converter 1, the disposition of each configuration illustrated in FIG. 2 is an example, and the disposition of each configuration is not limited to the example illustrated in FIG. 2. For example, the reactor 120 may be disposed at a subsequent stage of the rectifier 130. In the following description, the voltage-current detector 501, the voltage detector 502, and the current detectors 313a and 313b may be collectively referred to as detectors. In addition, the voltage value and current value detected by the voltage-current detector 501, the voltage value detected by the voltage detector 502, and the current values detected by the current detectors 313a and 313b may be referred to as detection values.

The controller 400 is a first controller included in the power converter 1. The controller 400: acquires the voltage value and current value of the first AC power of the power supply voltage Vs from the voltage-current detector 501; acquires the voltage value of the power rectified by the rectifier 130 from the voltage detector 502; and acquires the current values of the second AC power having the desired amplitude and phase converted by the inverter 310 from the current detectors 313a and 313b. The controller 400 controls the operation of the inverter 310 by using the detection values detected by the detectors, specifically, the controller 400 controls on/off of the switching elements 311a to 311f included in the inverter 310. In the first embodiment, the controller 400 controls the operation of the inverter 310 so as to output the second AC power containing pulsation according to pulsation of the power flowing from the rectifier 130 into the smoothing capacitor 210 of the smoother 200 to the compressor 315, which is a load. The pulsation according to the pulsation of the power flowing into the smoothing capacitor 210 of the smoother 200 is, for example, pulsation that varies depending on the frequency of the pulsation of the power flowing into the smoothing capacitor 210 of the smoother 200. The controller 400 thereby controls the current flowing through the smoothing capacitor 210 of the smoother 200. Note that the controller 400 may not use all the detection values acquired from the detectors, and may perform the control using part of the detection values.

Hereinafter, a detailed operation of the controller 400 is described. In the first embodiment, in the power converter 1, since the load generated by the inverter 310 and the compressor 315 can be regarded as a constant load, the following explanation is based on the assumption that a constant current load is connected to the smoother 200 when viewed in terms of the current output from the smoother 200.

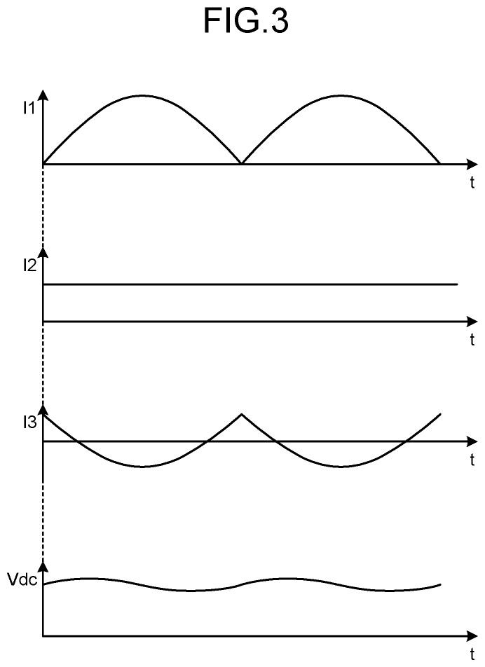

FIG. 3 is a diagram illustrating examples of the currents I1 to I3 and a smoothing capacitor voltage Vdc of the smoothing capacitor 210 of the smoother 200 when the current output from the rectifier 130 is smoothed by the smoother 200 and the current I2 flowing through the inverter 310 is made constant, as a comparative example. In order from the top, the current I1, the current I2, the current I3, and the smoothing capacitor voltage Vdc of the smoothing capacitor 210 generated according to the current I3 are illustrated. The vertical axis of the currents I1, I2, and I3 indicates a current value, and the vertical axis of the smoothing capacitor voltage Vdc indicates a voltage value. All horizontal axes indicate time t. Note that the carrier component of the inverter 310 are actually superimposed on the currents I2 and I3, but is omitted here. The same applies to the following. As illustrated in FIG. 3, in the power converter 1, if the current I1 flowing from the rectifier 130 is sufficiently smoothed by the smoother 200, the current I2 flowing through the inverter 310 has a constant current value. However, a large current I3 flows through the smoothing capacitor 210 of the smoother 200, which causes deterioration of the smoothing capacitor 210. Therefore, in the first embodiment, in the power converter 1, the controller 400 controls the current I2 flowing through the inverter 310, that is, controls the operation of the inverter 310 such that the current I3 flowing through the smoother 200 is reduced.

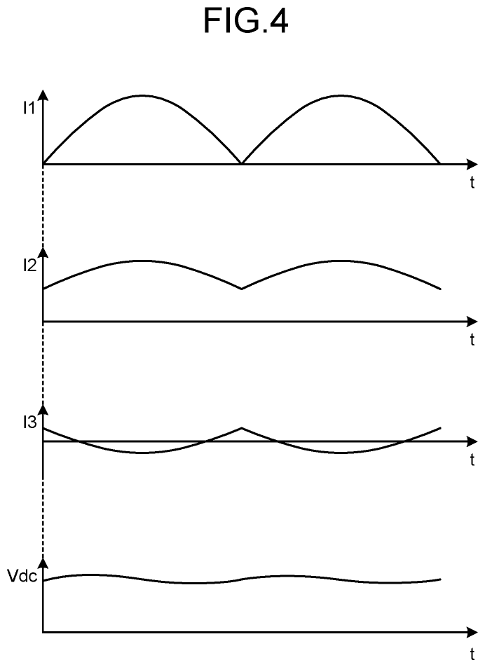

FIG. 4 is a diagram illustrating examples of the currents I1 to I3 and the smoothing capacitor voltage Vdc of the smoothing capacitor 210 of the smoother 200 when the controller 400 of the power converter 1 according to the first embodiment controls the operation of the inverter 310 to reduce the current I3 flowing through the smoother 200. In order from the top, the current I1, the current I2, the current I3, and the smoothing capacitor voltage Vdc of the smoothing capacitor 210 generated according to the current I3 are illustrated. The vertical axis of the currents I1, I2, and I3 indicates a current value, and the vertical axis of the smoothing capacitor voltage Vdc indicates a voltage value. All horizontal axes indicate time t. The controller 400 of the power converter 1 controls the operation of the inverter 310 such that the current I2 as illustrated in FIG. 4 flows through the inverter 310, thereby reducing the pulsation component of the current flowing from the rectifier 130 to the smoother 200 as compared with the examples in FIG. 3, and thus can reduce the current I3 flowing through the smoother 200. Specifically, the controller 400 controls the operation of the inverter 310 such that the current I2 containing a pulsation current having the frequency component of the current I1 as a main component flows through the inverter 310.

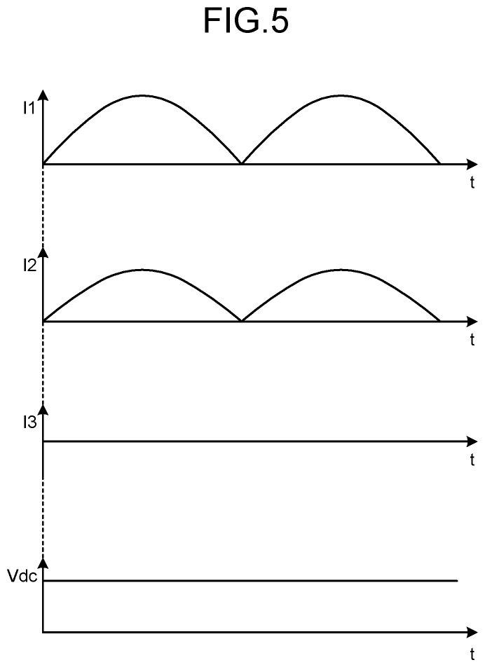

The ripple, that is, pulsation component contained in the current I1 is determined by the frequency of the AC current supplied from the AC power supply 110 and the configuration of the rectifier 130. Therefore, the controller 400 can make the frequency component of the pulsation current to be superimposed on the current I2 a component having a predetermined amplitude and phase. In the example in FIG. 4, a pulsation current having ½ the amplitude and the same phase with respect to the pulsation component contained in the current I1 is superimposed on the current I2. The controller 400 reduces the current I3 flowing through the smoother 200 as the pulsation current to be superimposed on the current I2 approaches the pulsation component contained in the current I1, and thus can reduce the pulsation voltage generated in the smoothing capacitor voltage Vdc. For example, as in the examples in FIG. 5, when the amplitude of the pulsation current to be superimposed on the current I2 is set to be the same as the amplitude of the pulsation component contained in the current I1, that is, when the pulsation current to be superimposed on the current I2 and the pulsation component contained in the current I1 are the same, the current I3 flowing through the smoother 200 becomes zero, and the smoothing capacitor voltage Vdc is constant. Note that FIG. 5 is a diagram illustrating other examples of the currents I1 to I3 and the smoothing capacitor voltage Vdc of the smoothing capacitor 210 of the smoother 200 when the controller 400 of the power converter 1 according to the first embodiment controls the operation of the inverter 310 to reduce the current I3 flowing through the smoother 200.

The controller 400 controlling the operation of the inverter 310 to control the pulsation of the current flowing through the inverter 310 is the same as controlling the pulsation of the second AC power output from the inverter 310 to the compressor 315. The controller 400 controls the operation of the inverter 310 such that the pulsation of the current I3 is smaller than the pulsation of the current I3 illustrated in the example in FIG. 3.

The AC current supplied from the AC power supply 110 is not particularly limited, and may be single-phase or three-phase. The controller 400 is only required to determine the frequency of the pulsation current to be superimposed on the current I2 according to the first AC power supplied from the AC power supply 110. Specifically, when the first AC power supplied from the AC power supply 110 is single-phase, the controller 400 performs control such that the frequency of the pulsation current to be superimposed on the current I2 flowing through the inverter 310 is twice the frequency of the first AC power. Alternatively, when the first AC power supplied from the AC power supply 110 is three-phase, the controller 400 performs control such that the frequency of the pulsation current to be superimposed on the current I2 flowing through the inverter 310 is six times the frequency of the first AC power. The waveform of the pulsation current to be superimposed on the current I2 is, for example, a shape of an absolute value of a sine wave or a shape of a sine wave.

The controller 400: may use the voltage applied to the smoothing capacitor 210 or the current flowing through the smoothing capacitor 210 to calculate a pulsation amount that is the amplitude of the pulsation to be superimposed on the second AC power output from the inverter 310; or may use the voltage or current of the first AC power supplied from the AC power supply 110 to calculate a pulsation amount of pulsation contained in the second AC power output from the inverter 310.

As described with reference to FIGS. 3 to 5, the power converter 1 according to the first embodiment controls the operation of the inverter 310 such that the pulsation current having a waveform according to the pulsation component of the current I1 output from the rectifier 130 is superimposed on the current I2 to be input to the inverter 310, thereby controlling the pulsation of the current I3 flowing through the smoother 200. However, there is an upper limit to the current value that can flow through the inverter 310, and there is also a limit to the amount of control of the current I3 flowing through the smoother 200. Therefore, by connecting the DC-DC converter 600 across the smoother 200 and causing the DC-DC converter 600 to consume the first DC power output from the smoother 200, the power converter 1 reduces the current I3 flowing through the smoother 200. Note that circuits corresponding to the DC-DC converter 600, the voltage detector 601, and the DC-DC converter controller 700 of the power converter 1 are also included in a general power converter, and a configuration in which the first DC power output from the smoother 200 is consumed by the DC-DC converter 600 does not increase the size of the apparatus.

Note that the examples illustrated in FIGS. 3 to 5 are based on the assumption that the compressor 315 is a constant torque load, but depending on the type of the compressor 315, the torque may periodically vary according to the rotation of the motor 314 included in the compressor 315. When the compressor 315 configured such that the load torque pulsates is connected to the inverter 310, pulsation according to the pulsation component of the load torque is generated in the current I3 flowing through the smoother 200. Therefore, when the load torque pulsates, the controller 400 controls the operation of the inverter 310 such that a pulsation current having the waveform according to the pulsation component of the load torque is superimposed on the current I2 to be input to the inverter 310 in addition to the pulsation current having the waveform according to the pulsation component of the current I1 output from the rectifier 130. The pulsation current having a waveform according to the pulsation component of the load torque is a current having a pulsation component having the same frequency and phase as the pulsation of the load torque. By performing such control, it is possible to control the pulsation according to the pulsation component of the load torque from being generated in the current I3 flowing through the smoother 200.

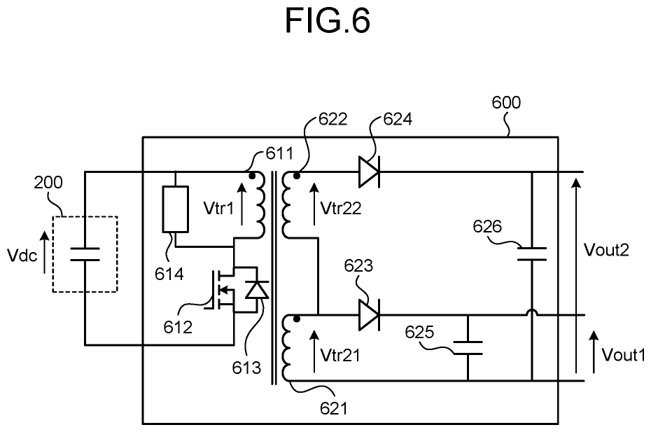

Next, a configuration of the DC-DC converter 600 is described. FIG. 6 is a diagram illustrating a configuration example of the DC-DC converter 600 of the power converter 1 according to the first embodiment.

The DC-DC converter 600 is an isolated DC-DC converter and converts the first DC power output from the smoother 200 into the second DC power having a desired voltage. The DC-DC converter 600 is configured to be able to output, as the second DC power, a DC power having a voltage of Vout1 and a DC power having a voltage of Vout2. Although not illustrated in FIG. 6, the second DC power is output to the load 800.

The DC-DC converter 600 includes a coil 611, a switching element 612, a freewheeling diode 613, and a surge voltage suppression circuit 614 on a primary side, and includes coils 621 and 622, rectifier elements 623 and 624, and capacitors 625 and 626 on a secondary side. On the primary side of the DC-DC converter 600, the switching element 612 and the freewheeling diode 613 are connected in parallel, and these elements and the coil 611 are connected in series. The surge voltage suppression circuit 614 constituted by a resistor, a capacitor, and the like is connected in parallel to the coil 611. On the secondary side of the DC-DC converter 600, the coil 621 and the coil 622 are connected in series. The coil 621 and the coil 622 are connected in parallel to the capacitor 626 via the rectifier element 624. The rectifier element 624 includes an anode connected to the coil 622 and a cathode connected to the capacitor 626. In addition, the coil 621 is connected in parallel to the capacitor 625 via the rectifier element 623. The rectifier element 623 includes an anode connected to the coil 621 and a cathode connected to the capacitor 625. Note that: the coil 621, the rectifier element 623, and the capacitor 625 constitute a circuit that generates the DC power having the voltage Vout1; and the coil 621, the coil 622, the rectifier element 624, and the capacitor 626 constitute a circuit that generates the DC power having the voltage Vout2.

The DC-DC converter 600: turns on and off the switching element 612 under the control of the DC-DC converter controller 700, which is not illustrated; converts the first DC power output from the smoother 200 into the DC power having the voltage Vout1 and the DC power having the voltage Vout2; and outputs the converted power to the load 800. Note that, in the configuration example illustrated in FIG. 6, one switching element 612 is included on the primary side of the DC-DC converter 600, but two or more switching elements may be included on the primary side. In addition, although the DC-DC converter 600 is configured to generate and output two types of DC power having different voltages, the DC-DC converter 600 may be configured to generate and output three or more types of DC power having different voltages or a single type of DC power. For example, when the DC-DC converter 600 is configured to generate a single DC power, one coil, one rectifier element, and one capacitor are only required to be included.

The voltage detector 601 detects a voltage value of the second DC power generated by the DC-DC converter 600 and outputs the detected voltage value to the DC-DC converter controller 700. The DC-DC converter controller 700 is a second controller included in the power converter 1. The DC-DC converter controller 700 acquires the voltage value of the second DC power from the voltage detector 601 and controls the DC-DC converter 600 based on the acquired voltage value.

Here, in the power converter 1 illustrated in FIG. 2, the inverter 310 and the DC-DC converter 600 are configured to be individually controlled by different controllers (the controller 400, the DC-DC converter controller 700). The reason for such a configuration is that the control speed of the switching element, that is, the switching frequency is greatly different between the inverter 310 and the DC-DC converter 600, and the performance required for each controller is different. By separating the controller 400 from the DC-DC converter controller 700, each controller can be implemented by a component having appropriate performance.

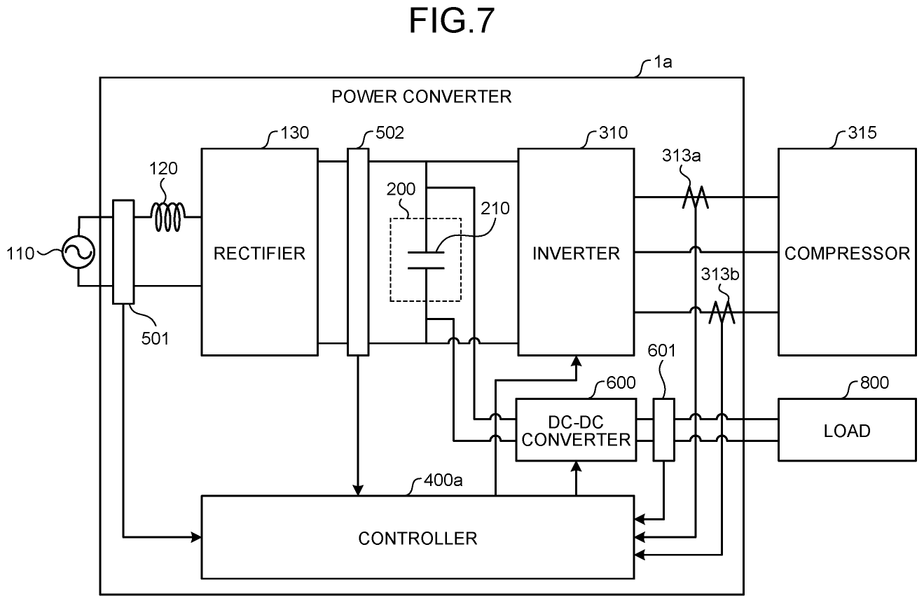

Note that a configuration to separate the controller 400 from the DC-DC converter controller 700 is not essential. The inverter 310 and the DC-DC converter 600 may be configured to be controlled by a single controller. In this case, the configuration is illustrated in FIG. 7. FIG. 7 is a diagram illustrating another configuration example of the power converter according to the first embodiment. A power converter 1a illustrated in FIG. 7 is obtained by replacing the controller 400 and the DC-DC converter controller 700 of the power converter 1 illustrated in FIG. 2 with a controller 400a. The controller 400a controls the inverter 310 and the DC-DC converter 600. The controller 400a performs the control of the inverter 310 by the controller 400 described above and the control of the DC-DC converter 600 by the DC-DC converter controller 700 described above. In the case of the configuration illustrated in FIG. 7, the control of the inverter 310 and the DC-DC converter 600 is performed by one component, which can make the processing more complex, increase the processing load of the component, and require a higher performance component, but the apparatus can be downsized as the number of components is reduced. In addition, the operation of the inverter 310 and the operation of the DC-DC converter 600 can be synchronized, which enables more efficient control to reduce the current flowing through the smoothing capacitor 210.

Next, the operation in which the DC-DC converter controller 700 of the power converter 1 and the controller 400a of the power converter 1a control the DC-DC converter 600 is described. Here, as an example, a case in which the controller 400a of the power converter la controls the DC-DC converter 600 is described. Note that the DC-DC converter controller 700 of the power converter 1 can also perform similar control.

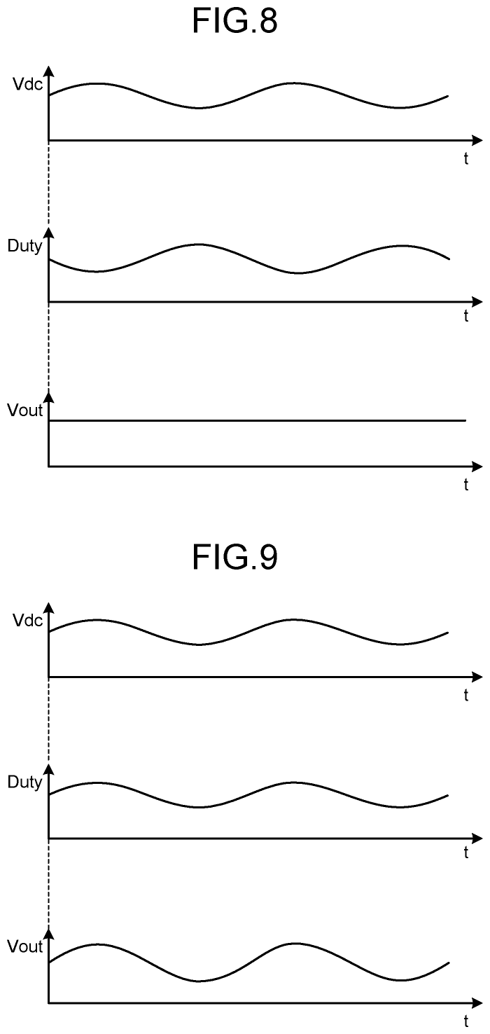

FIG. 8 is a diagram illustrating examples of waveforms indicating the operation of the DC-DC converter 600 constituting the power converter 1a according to the first embodiment. FIG. 8 illustrates a signal waveform of each unit when the controller 400a causes the switching element 612 of the DC-DC converter 600 to perform switching at a duty ratio according to the voltage value acquired from the voltage detector 601. The waveforms illustrated in FIG. 8 indicate, in order from the top, the smoothing capacitor voltage Vdc, a duty ratio Duty of the switching operation of the switching element 612, and the voltage Vout of the DC power output from the DC-DC converter 600. The horizontal axis indicates time t. The vertical axes of the voltages Vdc and Vout indicate voltage values.

As illustrated in FIG. 8, the controller 400a controls the duty ratio such that the output voltage Vout of the DC-DC converter 600 is constant. Specifically, the controller 400a causes the switching element 612 to perform switching while controlling the duty ratio so as to be a local maximum at the local minimum point of the pulsation generated in the smoothing capacitor voltage Vdc and to be a local minimum at the local maximum point. The average duty ratio obtained by excluding the pulsation component from the duty ratio is determined on the control from the relationship between the average voltage of Vdc and the average voltage of Vout, and the pulsation component to be superimposed on the duty ratio is determined on the control to cancel the pulsation component of Vdc. The voltage detector 601 detects the voltage containing the pulsation component generated in Vout, and the 400a controls the DC-DC converter 600 to cancel the pulsation component, which enables the operation illustrated in FIG. 8. Note that FIG. 8 illustrates that all pulsation components generated in Vout are canceled. The pulsation component to be superimposed on the duty ratio can be adjusted by control adjustment, and the amount of the pulsation component generated in Vout can be adjusted accordingly. By controlling the duty ratio in this manner, the pulsation of the output voltage Vout of the DC-DC converter 600 can be reduced and brought close to a constant value. As a result, the current flowing through the capacitors 625 and 626 included in the DC-DC converter 600 is also reduced, and it is possible to reduce the capacitances of the capacitors 625 and 626.

Another example in which the controller 400a controls the DC-DC converter 600 is described. FIG. 9 is a diagram illustrating other examples of waveforms indicating the operation of the DC-DC converter 600 constituting the power converter 1a according to the first embodiment. FIG. 9 illustrates a signal waveform of each unit when the controller 400a causes the switching element 612 of the DC-DC converter 600 to perform switching at a duty ratio according to the voltage values acquired from the voltage detector 502 and the voltage detector 601. In the example illustrated in FIG. 9, the controller 400a controls the operation of the DC-DC converter 600 so as to output the second DC power on which the pulsation similar to the pulsation generated in the smoothing capacitor voltage Vdc is superimposed. Specifically, the controller 400a causes the switching element 612 to perform switching while controlling the duty ratio so as to be a local minimum at the local minimum point of the pulsation generated in the smoothing capacitor voltage Vdc and to be a local maximum at the local maximum point. Similarly to FIG. 8, the average duty ratio obtained by excluding the pulsation component from the duty ratio is determined on control from the relationship between the average voltage of Vdc and the average voltage of Vout. The pulsation component to be superimposed on the duty ratio is determined on the control so as to be similar to the pulsation component of Vdc. The pulsation component generated in Vdc is detected by the voltage detector 502, and this component is controlled to be superimposed on the duty ratio as in the inverter 310 illustrated in FIGS. 4 and 5. The pulsation component to be superimposed on the duty ratio can be adjusted by control adjustment, and the amount of the pulsation component generated in Vout can be adjusted accordingly. As a result, it is possible to reduce the current flowing through the smoothing capacitor 210 and to downsize the smoothing capacitor 210.

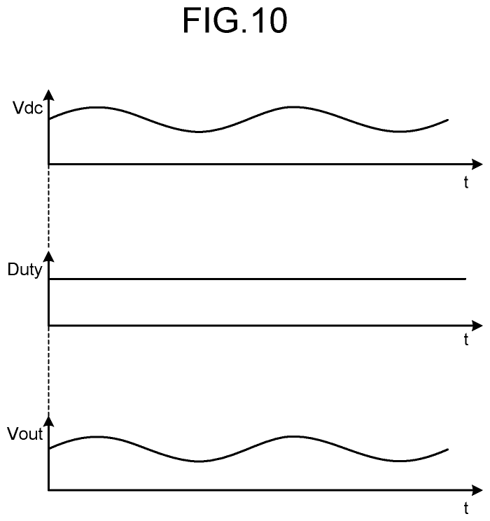

Another example in which the current flowing through the smoothing capacitor 210 can be reduced similarly to the example illustrated in FIG. 9 is described. FIG. 10 is a diagram illustrating other examples of waveforms indicating the operation of the DC-DC converter 600 constituting the power converter la according to the first embodiment. FIG. 10 illustrates operation waveforms of the DC-DC converter 600 when the switching element 612 performs switching at an average duty ratio without superimposing the pulsation component generated in Vdc or Vout on the duty ratio. Similarly to FIGS. 8 and 9, the average duty ratio obtained by excluding the pulsation component from the duty ratio is determined on control from the relationship between the average voltage of Vdc and the average voltage of Vout. When the DC-DC converter 600 is controlled at an average duty ratio, the DC-DC converter 600 also outputs the pulsation component generated in Vdc to Vout. As a result, it is possible to reduce the current flowing through the smoothing capacitor 210 and to downsize the smoothing capacitor 210.

In this case, unlike the control illustrated in FIG. 9, the DC-DC converter 600 is not controlled by detecting the pulsation component generated in Vdc, and thus can be controlled based on only Vout as in the example illustrated in FIG. 8. On the other hand, since the pulsation component generated in Vdc is not actively controlled to be output from the DC-DC converter 600 as in the control illustrated in FIG. 9, the amplitude of the output voltage Vout of the DC-DC converter 600 is larger in the case of FIG. 9 in which the duty ratio is controlled, as can be seen from the comparison between the waveform of FIG. 9 and the waveform of FIG. 10.

Whether the voltage pulsation generated in Vdc is caused by the AC power supply 110 or by a constant torque load, the capacitance of the smoothing capacitor 210 or the capacitors 625 and 626 can be reduced by controlling the DC-DC converter 600 at the duty ratio according to the voltage values acquired from the voltage detector 502 and the voltage detector 601.

When the controller 400a operates the DC-DC converter 600 so as to output the second DC power on which the pulsation similar to the pulsation generated in the smoothing capacitor voltage Vdc is superimposed, the current flowing through the smoothing capacitor 210 can be reduced, but the amplitude of the output voltage Vout of the DC-DC converter 600 increases. When the amplitude increases, the maximum voltage applied to the rectifier elements 623 and 624 on the secondary side of the DC-DC converter 600 exceeds the withstand voltage of the rectifier elements 623 and 624, and the apparatus may fail. In addition, the minimum voltage applied to the rectifier elements 623 and 624 dips below the lower limit value of the output voltage of the DC-DC converter 600, and the operation of the load 800 may stop. Therefore, the controller 400a controls the switching element 612 such that the voltages generated in the coils 621 and 622 on the secondary side are in a predetermined range.

In the power converter 1a, the upper limit and the lower limit of the voltages generated in the coils 621 and 622 on the secondary side of the DC-DC converter 600 are determined as follows. Here, as illustrated in FIG. 6, the voltage generated in the coil 611 on the primary side when the switching element 612 performs switching is Vtr1, and the voltages generated in the coils 621 and 622 on the secondary side are Vtr21 and Vtr22, respectively.

In addition, lower limit values of the two-stage voltages Vout1 and Vout2 output from the DC-DC converter 600 are Vout1_min and Vout2_min, respectively. For example, the voltage Vout1_min is set to a lower limit value of the voltage at which the current flows in the forward direction of the rectifier element 623 or a value larger than this value, and the voltage Vout2_min is set to a lower limit value of the voltage at which the current flows in the forward direction of the rectifier element 624 or a value larger than this value. Furthermore, the withstand voltage of the rectifier element 623 is Vdi23_max, and the withstand voltage of the rectifier element 624 is Vdi24_max.

In this case, the controller 400a controls the switching element 612 such that Vtr21 and Vtr22 satisfy the following Formulae (1) and (2).

Vtr21≤Vdi23_max . . . (1)

Vtr21+Vtr22≤Vdi24_max . . . (2)

That is, the controller 400a controls the switching element 612 such that the voltage (Vtr21) generated in the coil 621 is equal to or less than the withstand voltage of the rectifier element 623 and that the sum (Vtr21+Vtr22) of the voltage generated in the coil 621 and the voltage generated in the coil 622 is equal to or less than the withstand voltage of the rectifier element 624.

Furthermore, the controller 400a controls the switching element 612 such that Vtr21 and Vtr22 satisfy the following Formulae (3) and (4).

Vout1_min<Vtr21 . . . (3)

Vout2_min<Vtr21+Vtr22 . . . (4)

That is, the controller 400a controls the switching element 612 such that the voltage (Vtr21) generated in the coil 621 is larger than the lower limit value of the output voltage Vout1 and that the sum (Vtr21+Vtr22) of the voltage generated in the coil 621 and the voltage generated in the coil 622 is larger than the lower limit value of the output voltage Vout2.

As described above, in the power converter 1 according to the first embodiment: the first AC power supplied from the AC power supply 110 is rectified by the rectifier 130; the rectified power is smoothed by the smoother 200; the inverter 310 then converts the first DC power output from the smoother 200 into the second AC power and outputs the second AC power to the compressor 315; and the DC-DC converter 600 converts the first DC power into the second DC power and outputs the second DC power to the load 800. At this time, the inverter 310 reduces the current I3 flowing through the smoother 200 by causing the second AC power to contain the pulsation component according to the pulsation of the power flowing from the rectifier 130 into the smoother 200. As a result, it is possible to suppress the deterioration of the smoothing capacitor 210 and reduce the capacity, as compared with the case in which no control is performed to contain the pulsation component according to the pulsation of the power flowing into the smoother 200 in the second AC power. For example, when a plurality of smoothing capacitors 210 constitute the smoother 200, the number of smoothing capacitors 210 constituting the smoother 200 can be reduced. In addition, the DC-DC converter 600 changes the duty ratio when causing the switching element 612 to perform switching according to the pulsation of the power flowing from the rectifier 130 into the smoother 200. As a result, it is possible to control the pulsation of the output voltages Vout1 and Vout2 of the DC-DC converter 600. Accordingly, it is possible to use capacitors with small capacitance as the capacitors 625 and 626 and to downsize the apparatus.

Although two types of DC power having different voltages are generated and output, when three or more types of DC power having different voltages are generated and output by adding transformer winding or the like, similar effects can be obtained by performing control such that the upper limits and the lower limits of all voltages satisfy such relationships.

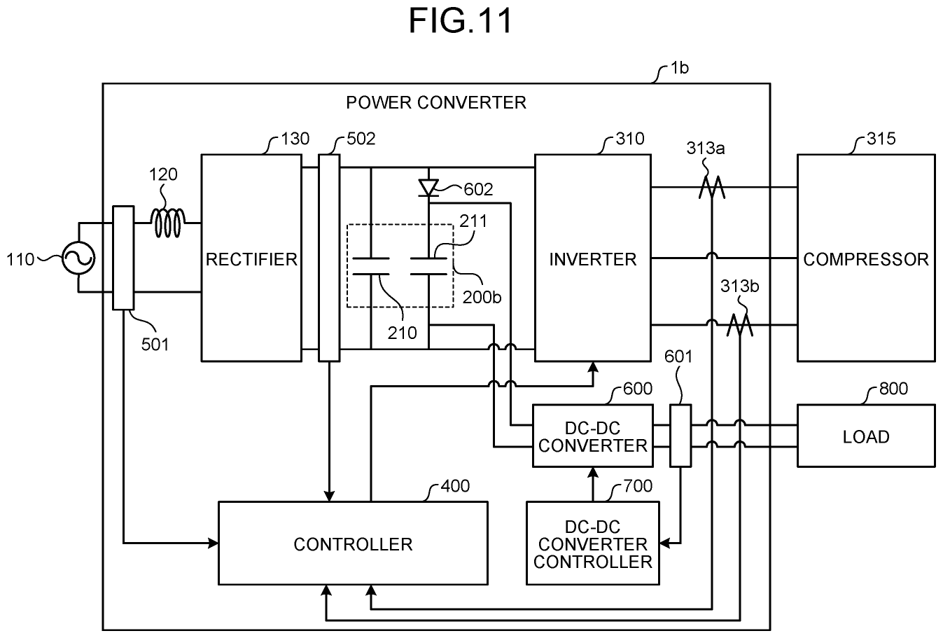

In the power converters 1 and 1a described above, the smoother 200 is constituted by the single smoothing capacitor 210, but the smoother 200 may be constituted by a plurality of smoothing capacitors. For example, a power converter 1b may have a configuration illustrated in FIG. 11. FIG. 11 is a diagram illustrating a modification of the power converter according to the first embodiment. The power converter 1b illustrated in FIG. 11 has a configuration in which the smoother 200 of the power converter 1 illustrated in FIG. 2 is replaced with a smoother 200b, and a rectifier element 602 is further added. In the power converter 1b, two smoothing capacitors 210 and 211 connected in parallel constitute the smoother 200b, and the rectifier element 602 is connected in series to the smoothing capacitor 211. The DC-DC converter 600 is connected in parallel to the smoothing capacitor 211. Since the operations of the inverter 310 and the DC-DC converter 600 of the power converter 1b are similar to those of the power 1, the description thereof is omitted. A rectifier element may also be connected in series to the smoothing capacitor 210. In addition, the smoother 200b may be constituted by three or more smoothing capacitors.

In the case of the power converter 1b, since the rectifier element 602 is connected in series to the smoothing capacitor 211 to which the DC-DC converter 600 is connected, it is possible to reduce the influence of the pulsation component of the voltage output from the rectifier 130 on the DC-DC converter 600.

Although FIG. 11 illustrates an example in which the smoother 200 of the power converter 1 is replaced with the smoother 200b and the rectifier element 602 is further added, it is also possible to replace the smoother 200 of the power converter 1a with the smoother 200b and add the rectifier element 602. In addition, the rectifier 130 of the power converters 1 to 1b may include a booster circuit that boosts the power obtained by rectifying the first AC power to improve the power factor.

Next, a hardware configuration of each controller (the controller 400 or 400a) included in each power converter (power converter 1, 1a, or 1b) described in the first embodiment is described. Note that the hardware configuration of each controller is similar.

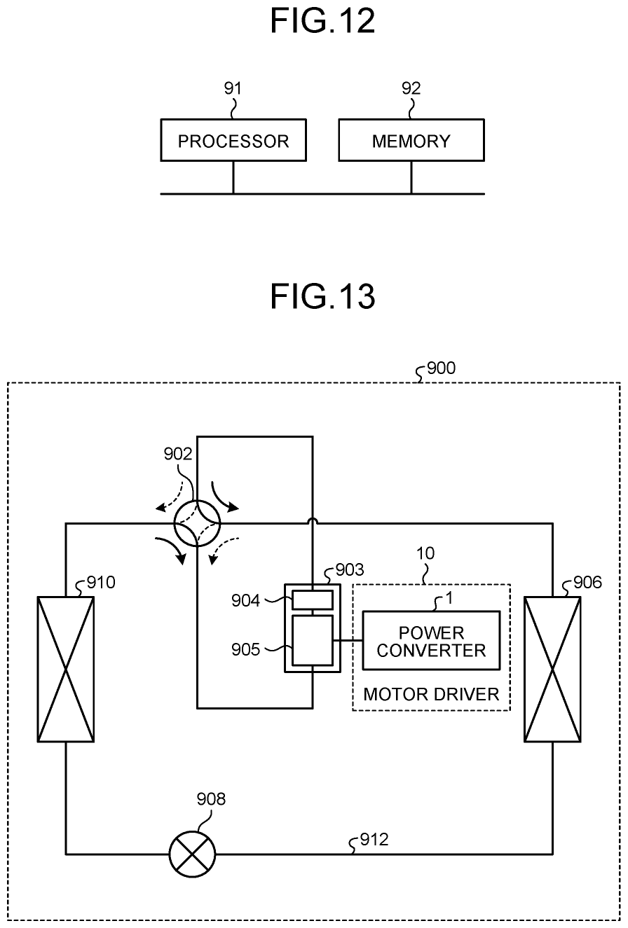

FIG. 12 is a diagram illustrating an example of a hardware configuration that implements the controller included in the power converter. The controller of the power converter is implemented by, for example, a processor 91 and a memory 92 illustrated in FIG. 12.

The processor 91 is a Central Processing Unit (also referred to as a CPU, a processing unit, an arithmetic unit, a microprocessor, a microcomputer, a processor, or a Digital Signal Processor (DSP)). The memory 92 is a Random Access Memory (RAM), a Read Only Memory (ROM), a flash memory, an Erasable Programmable Read Only Memory (EPROM), an Electrically Erasable Programmable Read Only Memory (EEPROM) (registered trademark), or the like.

The memory 92 stores a program for operating as the controller of the power converter. The controller of the power converter is implemented by the processor 91 reading and executing the program stored in the memory 92. The program stored in the memory 92 may be provided to a user or the like in a form of being written in a storage medium such as a Compact Disc (CD)-ROM or a Digital Versatile Disc (DVD)-ROM, or may be in a form of being provided via a network.

Note that the controller can also be implemented by a dedicated processing circuitry, for example, a single circuit, a composite circuit, an Application Specific Integrated Circuit (ASIC), a Field Programmable Gate Array (FPGA), or a circuit obtained by combining these circuits.

The DC-DC converter controller 700 of the power converter 1 can also be implemented by similar hardware.

### Second Embodiment

In the second embodiment, an apparatus that can be implemented by applying each power converter described in the first embodiment is described. As an example, a refrigeration-cycle applied equipment using the power converter 1 described in the first embodiment is described.

FIG. 13 is a diagram illustrating a configuration example of a refrigeration-cycle applied equipment 900 according to the second embodiment. The refrigeration-cycle applied equipment 900 according to the second embodiment includes a motor driver 10 to which the power converter 1 described in the first embodiment is applied.

In addition, the refrigeration-cycle applied equipment 900 includes a refrigeration cycle having a configuration in which a four-way valve 902, a compressor 903, a heat exchanger 906, an expansion valve 908, and a heat exchanger 910 are attached via a refrigerant pipe 912. The compressor 903 corresponds to the compressor 315 illustrated in FIG. 2 and the like.

The compressor 903 includes a compression mechanism 904 that compresses the refrigerant circulating in the refrigerant pipe 912, and a motor 905 that operates the compression mechanism 904.

The refrigeration-cycle applied equipment 900 having such a configuration can be used for, for example, an air conditioner, a heat pump water heater, a refrigerator, a freezer, or the like.

The configurations described in the above embodiments are merely examples and can be combined with other known techniques, the above embodiments can be combined with each other, and a part of the configurations can be omitted or changed without departing from the gist of the present disclosure.

1. A power converter comprising:
a rectifier configured to rectify a first alternating-current power supplied from an alternating-current power supply;
a smoother connected to output ends of the rectifier, and configured to:
smooth electric power obtained as a result the rectifier rectified the first alternating-current power; and
generate a first direct-current power;
an inverter configured to:
convert a first direct-current power supplied from the smoother into a second alternating-current power; and
output the second alternating-current power to a motor;
a first controller configured to control an operation of the inverter such that the second alternating-current power contain pulsation according to pulsation of power flowing into the smoother from the rectifier;
a DC-DC converter comprising at least one switching element, the DC-DC converter is configured to convert the first direct-current power, supplied from the smoother, into a second direct-current power by causing the switching element to perform switching; and
a second controller configured to cause the switching element to perform switching while changing, according to pulsation of power flowing into the smoother from the rectifier, a duty ratio when the switching element performs switching.

2. The power converter according to claim 1, wherein
the first controller is configured to control the operation of the inverter such that the second alternating-current power contains pulsation having the same frequency and phase as the first alternating-current power.

3. The power converter according to claim 1, wherein
when torque of the motor pulsates,
the first controller is configured to control the operation of the inverter such that the second alternating-current power further contains pulsation having the same frequency and phase as the pulsation of the torque of the motor.

4. The power converter according to claim 1, wherein
the second controller is configured to cause the switching element to perform switching such that the duty ratio is a local minimum at a local maximum point of a voltage of the smoother and that the duty ratio is a local maximum at a local minimum point of the voltage of the smoother.

5. The power converter according to claim 1, wherein
the DC-DC converter is an isolated DC-DC converter,
the DC-DC converter comprises at least one switching element on a primary side and at least one rectifier element on a secondary side, and
the second controller is configured to control the switching element such that a voltage to be applied to the rectifier element is less than a withstand voltage of the rectifier element at a point when a voltage of the second direct-current power is a local maximum.

6. The power converter according to claim 1, wherein
the DC-DC converter is an isolated DC-DC converter,
the DC-DC converter comprises at least one switching element on a primary side and at least one rectifier element on a secondary side, and
the second controller is configured to control the switching element such that a voltage to be applied to the rectifier element exceeds a lower limit value of a voltage at which a current flows through the rectifier element at a point when a voltage of the second direct-current power is a local minimum.

7. The power converter according to claim 1, wherein
the smoother is constituted by a plurality of smoothing capacitors connected in parallel,
the DC-DC converter is connected in parallel to one of the smoothing capacitors, and
the rectifier element is connected in series to the smoothing capacitor connected to the DC-DC converter.

8. The power converter according to claim 1, wherein
the DC-DC converter is configured to:
generate two or more types of direct-current power as the second direct-current power; and
supply the two or more types of direct-current power to each of a plurality of loads having different operating voltages.

9. The power converter according to claim 1, wherein
the rectifier is configured to boost and output a power obtained by rectifying the first alternating-current power.

10. The power converter according to claim 1, wherein
the first controller and the second controller are implemented by different circuits.

11. The power converter according to claim 1, comprising
a single controller operating as the first controller and also operating as the second controller.

12. A motor driver comprising the power converter according to claim 1.

13. A refrigeration-cycle applied equipment comprising the power converter according to claim 1.
